(19) United States
(12) Patent Application Publication
(10) Pub. No.: US 2005/0270702 A1
(43) Pub. Date: Dec. 8, 2005

(54) Magnetoresistance effect element

(75) Inventors: Koujiro Komagaki, Kawasaki (JP); Kenji Noma, Kawasaki (JP)

Correspondence Address: Patrick G. Burns, Esq.;GREER, BURNS, & CRAIN, LTD., 300 South Wacker Dr., Suite 2500, Chicago, IL, 60606, US

(73) Assignee: FUJITSU LIMITED

(21) Appl. No.: 10/973,319

(22) Filed: Oct. 26, 2004

(30) Foreign Application Priority Data
Jun. 8, 2004 (JP) 2004-169974

(51) Int. Cl. G11B 5/33; G11B 5/127

(52) U.S. Cl. 360/319; 360/324.1

(57) ABSTRACT

The magnetoresistance effect element can be manufactured by a conventional process and is capable of restricting influences of noises or leaked magnetic signals so that magnetic recording density can be highly improved. The magnetoresistance effect element comprises: a magnetoresistance film including a free layer; and shielding sections being respectively provided on the both sides of the free layer in a direction of track width, the shielding sections being soft magnetic films.

### BACKGROUND OF THE INVENTION

The present invention relates to a magnetoresistance effect element.

Conventionally, spin valve type magnetoresistance effect elements, in which a magnetoresistance effect is gained by spin dependent scattering, have been mainly used for magnetic recording, They have been mainly assembled in CIP (Current In Plane) type magnetoresistance effect heads, in each of which a sensing current runs in parallel to an element plane. In the CIP type magnetoresistance effect heads, if their track widths are 0.1 μm or less, sensitivity of detecting variation of magnetoresistance is lowered. To solve this problem, CPP (Current Perpendicular to Plane) type magnetoresistance effect heads, in each of which a sensing current runs perpendicular to an element plane, and tunnel type magnetoresistance effect heads, each of which uses a tunneling phenomenon, have been proposed. Note that, conventional magnetoresistance effect elements are disclosed in, for example, Japanese Patent Gazettes No. 2000-195018 and No. 2003-77107.

FIG. 3 is a partial sectional view of the CIP type magnetoresistance effect element. A symbol 10 stands for a lower shielding layer; a symbol 20 stands for an upper shielding layer; a symbol 12 stands for a core section including a pinned magnetic layer; and a symbol 14 stands for a free layer (free magnetic layer). Symbols 16a and 16b stand for hard bias films for magnetic-domain-controlling the free layer 14. After the magnetoresistance effect film is formed, the hard bias films 16a and 16b are respectively forming on both side slope faces of the magnetoresistance effect film. Symbols 17a and 17b stands for electrodes provided between the hard bias films 16a and 16b and the upper shielding layer 20. An insulating layer 18 is formed between the hard bias films 16a and 16b and the lower shielding layer 10, and another insulating layer 18 is formed between the electrodes 17a and 17b and the upper shielding layer 20. A sensing current runs in parallel to the plane of the magnetoresistance effect film, and magnetic signals can be detected.

FIG. 4 is a partial sectional view of the CPP type magnetoresistance effect element. Note that, the members shown in FIG. 3 are assigned the same symbols. In the CPP type element, no electrode 17a and 17b are formed on the both sides of the core section 12; only the hard bias films 16a and 16b are respectively formed on the both sides thereof. One insulating layer 18 is formed between the hard bias films 16a and 16b, the lower shielding layer 10 and the core section 12, and another insulating layer 18 is formed between the electrodes 17a and 17b, the core section 12 and the upper shielding layer 20. A sensing current runs from the upper shielding layer 20 to the lower shielding layer 10. Namely, the current runs perpendicular to the plane of the magnetoresistance effect film, and magnetic signals can be detected. Note that, constitution of a tunnel type magnetoresistance effect element is similar to that shown in FIG. 4.

If track width and track pitch of a recording medium are made narrower so as to increase recording density, a magnetic head reads data leaked from an adjacent track. This phenomenon is called “side reading”. When the track width and the track pitch are narrower than width of a core of a magnetoresistance effect element, the side reading is occurred. Therefore, the track width and the track pitch cannot be narrower than the core width, so that increasing the recording density is limited.

To solve this problem, a small magnetoresistance effect element having a fine core was proposed, but it is very difficult to manufacture such element by a conventional process. Namely, miniaturizing the magnetoresistance effect element is limited.

### SUMMARY OF THE INVENTION

The present invention has been invented to solve the above described problems.

An object of the present invention is to provide a magnetoresistance effect element, which can be manufactured by the conventional process and which is capable of restricting influences of noises or magnetic signals leaked from adjacent tracks when recorded signals are reproduced whereby magnetic recording density can be highly improved.

To achieve the object, the present invention has following structures.

Namely, the magnetoresistance effect element comprising a magnetoresistance film including a free layer is characterized by shielding sections being respectively provided on the both sides of the free layer in a direction of track width, the shielding sections being soft magnetic films.

In the magnetoresistance effect element, the free layer may have a synthetic ferrimagnet structure, which includes a first free layer, an antiferromagnetic coupling layer and a second free layer, and a coercive force of the free layer may be 30 Oe or less. In the magnetoresistance effect element, the magnetoresistance effect element may be a CIP type element, in which a sensing current runs in parallel to a film plane of the magnetoresistance film.

In the magnetoresistance effect element, the magnetoresistance effect element may be a CPP type spin valve element or tunnel MR element, in which the shielding sections and a lower shielding layer is separated by an insulating layer.

In the magnetoresistance effect element, the magnetoresistance effect element may be a CPP type spin valve element or tunnel MR element, in which the shielding sections and an upper shielding layer is separated by an insulating layer.

In the magnetoresistance effect element, thickness of the shielding sections may be effectively thicker than that of the free layer.

By using the magnetoresistance effect element of the present invention, data recorded in fine tracks can be read without side reading, so that bad influences caused by noises or signals leaked from adjacent tracks can be prevented. Therefore, recording density can be highly improved.

### BRIEF DESCRIPTION OF THE DRAWINGS

Embodiments of the present invention will now be described by way of examples and with reference to the accompanying drawings, in which:

FIG. 1 is a partial sectional view of a CIP type magnetoresistance effect element of the present invention;

FIG. 2 is a partial sectional view of a CPP type magnetoresistance effect element of the present invention;

FIG. 3 is the partial sectional view of the conventional CIP type magnetoresistance effect element; and

FIG. 4 is the partial sectional view of the conventional CPP type magnetoresistance effect element.

### DETAILED DESCRIPTION OF THE EMBODIMENTS

Preferred embodiments of the present invention will now be described in detail with reference to the accompanying drawings.

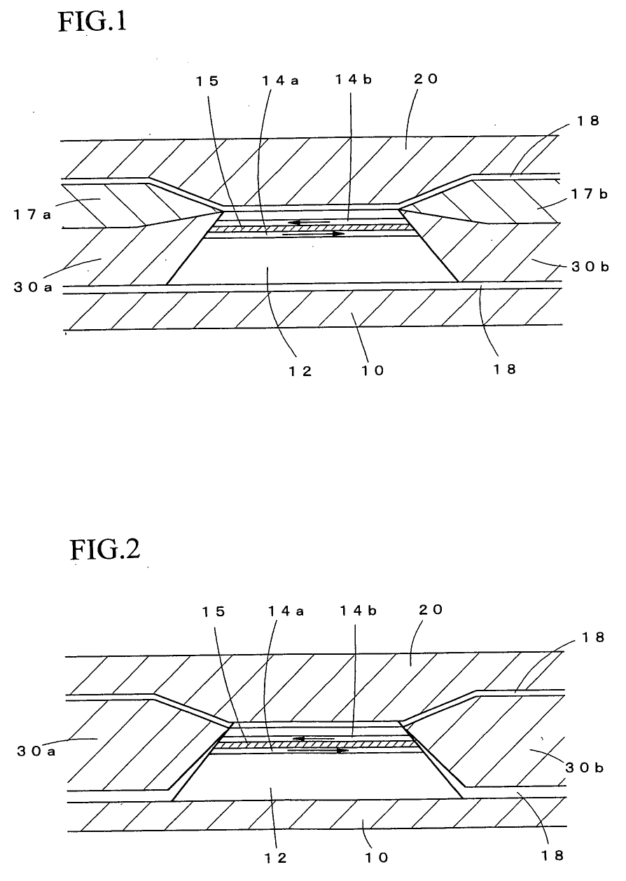

FIG. 1 shows a CIP type magnetoresistance effect element of an embodiment of the present invention.

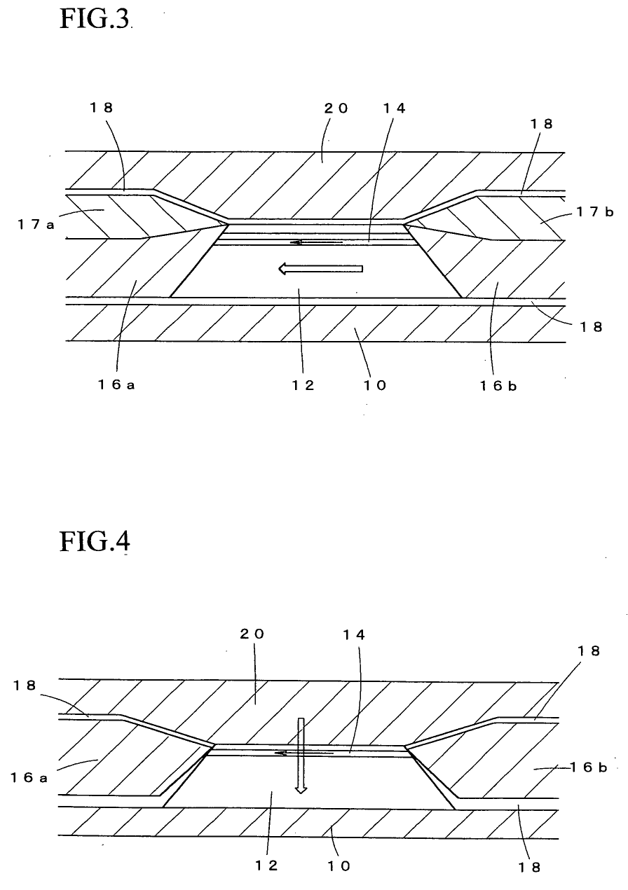

The CIP type magnetoresistance effect element includes a lower shielding layer 10, an upper shielding layer 20, a core section 12 and electrodes 17a and 17b as well as the conventional CIP type magnetoresistance effect element shown in FIG. 3. The unique features of the present embodiment are: (1) providing shielding sections 30a and 30b, which are made of a soft magnetic material, on both sides of a free layer of the core section 12 instead of the hard bias films 16a and 16b shown in FIG. 3; and (2) the free layer having a two-layered structure, which includes a first free layer 14a and a second free layer 14b coupled by an antiferromagnetic coupling layer 15.

The shielding sections 30a and 30b are provided so as not to leak magnetic fluxes from adjacent tracks, so that no leaked magnetic fluxes work to the core section 12. The hard bias films 16a and 16b (see FIG. 3) are made of a ferromagnetic material, e.g., CoCrPt, CoPt; the shielding sections 30a and 30b of the present embodiment are made of the soft magnetic material, e.g., NiFe, FeSiB, Mn—Zn ferrite, which is capable of highly shielding magnetism.

In the case of a magnetoresistance effect element, in which a magnetoresistance effect film is exposed in an air bearing surface, the shielding sections 30a and 30b respectively face adjacent tracks when the core section 12 faces an object track. Therefore, magnetic fluxes, which are leaked from the adjacent tracks and work to the core section 12, can be effectively shielded by the shielding sections 30a and 30b. Even if width of the core section 12 is equal to that of the conventional core section, the leaked magnetic fluxes working to the core section 12 can be restricted, so that noises can be reduced while detecting magnetic signals.

In FIG. 1, the first free layer 14a, the antiferromagnetic coupling layer 15 and the second free layer 14b are piled in this order. The layered structure is a synthetic ferrimagnet structure, in which the first and second free layers 14a and 14b are self-biased for magnetic domain control.

For example, CoFe, NiFe/CoFe, CoFeB, NiFeCo or Co may be used as the first free layer 14a; Ru, Ir, Rh or Cu may be used as the antiferromagnetic coupling layer 15; and CoFe, NiFe/CoFe, CoFeB, NiFeCo or Co may be used as the second free layer 14b.

By employing the synthetic ferrimagnet structure, an interaction between the first and second free layers 14a and 14b with the antiferromagnetic coupling layer 15 makes magnetic moments of the free layers 14a and 14b antiparallel and directs each of them in one direction. Therefore, one-directional magnetic anisotropy works to each of the free layers 14a and 14b, and the free layers 14a and 14b are self-biased for magnetic domain control.

Note that, a desired coercive force the synthetic ferrimagnet structure including the free layers 14a and 14b is 30 Oe or less. If the coercive force is greater than 30 Oe, the free layers' sensitivity of detecting signals from a magnetic recording medium must be lowered.

In the conventional CIP type magnetoresistance effect element, the single free layer 14 (see FIG. 3) is magnetic-domain-controlled by the hard bias films 16a and 16b. On the other hand, in the present embodiment, the first and second free layers 14a and 14b are magnetic-domain-controlled without providing the hard bias films 16a and 16b, so that magnetic signals can be detected with the sensitivity almost equal to that of the conventional element. Further, the shielding sections 30a and 30b are provided instead of the hard bias films 16a and 16b, so that noises or magnetic fluxes leaked from the adjacent tracks can be restricted. Therefore, the sensitivity of detecting magnetic signals can be highly improved.

FIG. 2 shows a CPP type magnetoresistance effect element of another embodiment. The structure of the CPP type magnetoresistance effect element is similar to that of the CIP magnetoresistance effect element shown in FIG. 1. In the conventional CPP type magnetoresistance effect element, the hard bias films 16a and 16b are respectively provided on the both sides of the free layer of the core section 12 (see FIG. 4). On the other hand, in the embodiment shown in FIG. 2, the shielding sections 30a and 30b, which are made of a soft magnetic material capable of highly shielding magnetism, are provided instead of the hard bias films 16a and 16b. Further, the free layer of the core sections 12 has the synthetic ferrimagnet structure, which includes the first free layer 14a, the antiferromagnetic coupling layer 15 and the second free layer 14b.

In the embodiment shown in FIG. 2 too, the shielding sections 30a and 30b shield the magnetic fluxes leaked from adjacent tracks. By employing the synthetic ferrimagnet structure including the first and second free layers 14a and 14b and the antiferromagnetic coupling layer 15, the free layers 14a and 14b are self-biased for magnetic domain control, so that magnetic signals can be detected. By shielding the magnetic fluxes leaked from adjacent tracks by the shielding sections 30a and 30b, noises can be reduced, so that sensitivity of the magnetoresistance effect element can be improved. The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

1. A magnetoresistance effect element,
comprising:
a magnetoresistance film including a free layer; and
shielding sections being respectively provided on the both sides of the free layer in a direction of track width, said shielding sections being soft magnetic films.

2. The magnetoresistance effect element according to claim 1,
wherein the free layer has a synthetic ferrimagnet structure, which includes a first free layer, an antiferromagnetic coupling layer and a second free layer, and
wherein a coercive force of the free layer is 30 Oe or less.

3. The magnetoresistance effect element according to claim 1,
wherein said magnetoresistance effect element is a CIP type element, in which a sensing current runs in parallel to a film plane of the magnetoresistance film.

4. The magnetoresistance effect element according to claim 1,
wherein said magnetoresistance effect element is a CPP type spin valve element, in which said shielding sections and a lower shielding layer is separated by an insulating layer.

5. The magnetoresistance effect element according to claim 1,
wherein said magnetoresistance effect element is a CPP type tunnel MR element, in which said shielding sections and a lower shielding layer is separated by an insulating layer.

6. The magnetoresistance effect element according to claim 1,
wherein said magnetoresistance effect element is a CPP type spin valve element, in which said shielding sections and an upper shielding layer is separated by an insulating layer.

7. The magnetoresistance effect element according to claim 1,
wherein said magnetoresistance effect element is a CPP type tunnel MR element, in which said shielding sections and an upper shielding layer is separated by an insulating layer.

8. The magnetoresistance effect element according to claim 1,
wherein thickness of said shielding sections are effectively thicker than that of the free layer.
